(19) United States
(12) Patent Application Publication
(10) Pub. No.: US 2006/0207289 A1
(43) Pub. Date: Sep. 21, 2006

(54) Copper slag reclamation and recycling method

(76) Inventor: Roland D. Hale, Alfred Station, NY (US)

Correspondence Address: SHLESINGER & FITZSIMMONS, Suite 1323, 183 East Main Street, Rochester, NY, 14604, US

(21) Appl. No.: 11/082,435

(22) Filed: Mar. 17, 2005

(51) Int. Cl. C03B 1/00

(52) U.S. Cl. 65/17.1

(57) ABSTRACT

A formulation (process) and production of a hard, tough material of ferro matasilicate lattice crystals and dispersed crystals of lead, ferro, copper, zinc, and antimony spinels in glassy matrix. Variation of the degree of crystallinity and the ratio of crystals control the properties of the resultant product. These are controlled though formulation, processing conditions and residence times and through control of the heat history from tap out of the kiln to the final bagged product. Production of the product utilizes copper slag which is waste from the production and refining of copper. The component materials include: calcium, copper, arsenic, antimony, zinc, lead, and iron at very consistent levels of various oxide forms. The resultant process converts hazardous waste, such as copper slag (KO61), to a non-hazardous (TCLO criteria) product that contains no free silica. Product performance can be tailored to meet the needs of the loose grain abrasive market as speed and profile test have demonstrated. Embodiments include a glass-ceramic abrasive composition with about 40-60 weight percent copper slag, about 10-20 weight percent of soda lime glass, and about 0-20 weight percent silica sand and about 1020 weightpercent of alumina are mixed to yield an enteric melt at a temperature of about 2300-2800° F. for 3 to 5 hours. Then the melt continues at about one inch/minute at 2400-2900° F. in preparation for further annealing or heat treating to control crystalline growth. The composition has a Vickers hardness of at least about 5.5 gigaPascals, and a density of about 35-40 weight percent of an iron oxide. When the composition is tested in accordance with the Environmental Protection Agency's Toxicity Characteristic Leaching Procedure, it produces a leachate which contains no detectable parts per million of detectable lead, less then 0.3 parts per million of detectable antimony, less then 0.1 parts per million detectable cadmium, less than 0.005 parts per million of detectable arsenic, and less then 0.01 parts per million of detectable nickel.

### BACKGROUND AND SUMMARY

Copper and other metal slags or cinders, defined as more or less completely fused and vitrified matter separated during the reduction of a metal from its ore, are categorized by the Environmental Protection Agency (EPA) as hazardous wastes. Especially in the case of copper slags, concentration of toxic heavy metals is low and frequency distribution of all copper slag composites are narrow in chemical analysis. The amounts of heavy metals extracted by an aggressive standard acid leach procedure are low, and well below the US regulatory levels derived from drinking water standards. A waste is thus hazardous either because of national law or the inability to rebut two presumptions in the Basel Convention:
1. Wastes belong to any category contained in Annex I.
2. “Unless they do not possess any of the characteristics contained in Annex III.” (Latter Annex lists 14 hazardous characteristics, some without reference methods or numerical limits)

Slag, such as granulated slag from copper, is typically dumped near the plant or metal producing facility in a designated area The long-term effects on water pollution due to leachate generated from the resulting slag piles may not be guaranteed unless it is proven by TCLP.

The lack of information in open literature on TCLP test results demonstrates a prevailing attitude of indifference toward guaranteeing long term water pollution effects of slag pile leachates. Solid wastes produced from liquid effluents are no longer safe options unless these wastes are handled and managed or processed in environmentally-friendly manners adopting specified procedures laid down by pollution enforcement agencies. Hazardous constituents in slag after floating are dumped near the smelters can include selenium (Se), Te tellurium (re), mercury ([g), silver (Ag), arsenic (As), lead (Pb), and copper (Cu).

The conclusions regarding the chemical composition and possible environmental and health release of heavy metals from copper slags are based on analytical data in reports from 3 countries (US, Canada, and Chile) using TCLP leachate methods to determine hazardousness.

A way to reduce or eliminate slag piles from metal production facilities would be beneficial to the companies and possibly to the environment. Further, a way to capitalize on slags, such as by converting them into useful commercially viable products, while reducing or eliminating existing slag piles would be even more beneficial.

Embodiments provide a formulation (process) and production of a hard, tough material of ferro matasilicate lattice crystals and dispersed crystals of lead, ferro, copper, zinc, and antimony spinels in glassy matrix. Variation of the degree of crystailinity and the ratio of crystals control the properties of the resultant product. These are controlled though formulation, processing conditions and residence times and through control of the heat history from tap out of the kiln to the final bagged product. Production of the product utilizes copper slag which is waste from the production and refining of copper. The component materials include: calcium, copper, arsenic, antimony, zinc, lead, and iron at very consistent levels of various oxide forms. The resultant process converts hazardous waste, such as copper slag (KO61), to a non-hazardous (TCLO criteria) product that contains no free silica Product performance can be tailored to meet the needs of the loose grain abrasive market as speed and profile test have demonstrated.

Embodiments further include a glass-ceramic abrasive composition with about 40-60 weight percent copper slag, about 10-20 weight percent of soda lime glass, and about 0-20 weight percent silica sand and about 10-20 weightpercent of alumina are mixed to yield an enteric melt at a temperature of about 2300-2800° F. for 3 to 5 hours. Then the melt continues at about one inch/minute at 2400-2900° F. in preparation for further annealing or heat treating to control crystalline growth. The composition has a Vickers hardness of at least about 5.5 gigaPascals, and a density of about 35-40 weight percent of an iron oxide. When the composition is tested in accordance with the Environmental Protection Agency's Toxicity Characteristic Leaching Procedure, it produces a leachate which contains no detectable parts per million of detectable lead, less then 0.3 parts per million of detectable antimony, less then 0.1 parts per million detectable cadmium, less than 0.005 parts per million of detectable arsenic, and less then 0.01 parts per million of detectable nickel. Through the various methods and tools of controlling the quantity of crystal growth and types of crystals, phase and coupled with the knowledge of the hardness of various metallic oxide forms high quality products can be produced. Certain wastes are real assets and are important secondaries such as converter slag, and anode slag. For 1 ton of metal>2.2 tons of slag is produced for value added product like abrasive tools, pavement, abrasive, concrete, cutting tools, tiles, glass, roofing granules, cement, asphalt concrete aggregate.

The various tools to control the three phases in the product are formulation (i.e. levels of additive and silica sand for a given dust stream), heat history (allowing crystals to grow), and nucleating sites (i.e. areas for the crystals to grow). Lab scale and full scale on a product run coupled with post run annealing have demonstrated that toughness and hardness can be manipulated to achieve desirable performance competing with or exceeding performance of commercially used loose grain.

Embodiments thus provide an abrasive material that preferably is made by a process in which from about 40 to about 60 weight percent of copper slag and from about 20 to about 40 weight percent of glass are mixed in a ratio of from about 2:1 to about 4.5:1, melted at a temperature of from about 2300 to about 2800 degrees Fahrenheit, and then quenched.

### BRIEF DESCRIPTION OF THE DRAWINGS

FIG. 1 is a flow diagram illustrating one process of this invention.

### DESCRIPTION

As used herein, “glass” means a solid material that has no long range order in its atomic structure. Also as used herein, “ceramic” means a nonmetallic material comprised of a single crystal or of many small crystals (polycrystalline). Further as used herein, “reverberatory furnace” means a furnace or kiln in which the fuel is not in direct contact with the iron or metal to be heated, but furnishes a flame that plays over the material especially being deflected downward from the roof. Such furnaces are characterized or produced by reverberation and can be 90-130 ft long and 18-30 ft wide.

Glass and ceramic are mostly interrelated. This is possible because a material composition may be fabricated as a glass, a ceramic, or a combination of the two by thermal heat treatments. Glasses are super-cooled liquids of extremely high viscosity. If the material is cooled slowly enough, they can become ordered or crystalline.

Common glass, like window glass, is based on a silicate structure, SiO2, the same material used in many ceramics such as cookware. Silicon dioxide in pure form makes a very fine optical glass called fused silica. The temperature required is very high and is a high optical quality. Silica is called the universal solvent due to its ability to accept many ions in its structure while remaining quite stale in the presence of water, acids and bases. Other oxides are added to increase resistance to chemical corrosion and vary mechanical properties. Glass can be used as a coating for other materials to, for example, provide environmental protection or decorative effects. Such glass coatings on metals are typically called enamels and on ceramics are typically called glazes.

In a copper smelting facility, slag is typically removed from the furnace through two skimming bays located in the side wall and near the flue at the off-take. The slag is conveyed by a short metal landing to rail mounted slag pots that can have, for example, 225 ft³ capacity. The slag train is moved by a locomotive or the like to a slag dump located near the smelter building, such as within about approximately 1000 feet, although this distance can vary. The reverberatory furnace concentrates 15-30% copper through smelting and forming a “ccopper matte” of 25-45% copper. The chemistry of smelting involves chemical bonding of Copper Raving a greater attraction for sulfur than does iron.

The composition of a particular slag will depend on the metallurgical process by which it is produced and on the particular ore body extraction. Some of the elements likely to be present in copper slag are of more interest than others, from the point of view of environmental protection. Tables 1 and 2 below reflect the average composition of 26 slags from the United states, Canada, and Chile.

Under the EPA's recycling guidelines, any “hazardous waste” that is recycled and incorporated into a commercial product loses its original label as a “hazardous waste” as a matter of law, and is therefore no longer regulated as a waste. Having severed the legal and chemical liability trail, both the renovation and original generation of wastes are isolated from future hazardous waste liability. Once in commerce, vitrified products are regulated merely as a function of normal industrial guidelines, including compliance with material safety datasheets (MSDS) specifications.

As revealed by microscopic observations, copper slags are typically well crystallized and include iron oxides, silica, alumina, lime and magnesia Additionally, such slags typically include a total of about 95% oxide content. Diffraction patterns generated by slag exposed to X-rays indicate that the main phases of crystallinity of the slag include 2FeO SiO₂, Fe₃O₄, and Ca (FeMg) (SiO₃)₂. Since metals are most stable in the oxide and silicate forms, construction material produced from copper oxide have the least possibility of corroding.

Copper slag according to embodiments can be used as a ceramic raw material to make a coating for abrasive tools for machining non-ferrous metals, wood, and plastic. Additionally, copper slag according to the invention can be used to enhance the service properties of grinding wheels, such as ultimate strength, cutting characteristics, service life, and condition of working surface by using slag-based binders instead of ceramic binders. Embodiments use wheels to lower porosity of the ground surface, resulting in higher grinding efficiency and reduced energy usage. Polyurethane resin is preferred over aluminum for the grinding wheel.

Embodiments employ finely ground copper slag in concrete to increase the strength of the resulting mixture as compared to concrete without copper slag added. Additives such as alumina and electric arc furnace dust in copper slag fines can also increase strength and durability. As with copper slag, dust fines of additives appeared to produce a stronger material.

Slag softening at 1190° C. is unsuitable for ceramic bond abrasive. Heat treatment at 800-1000° C. improves mechanical properties of slag and the abrasive, as good as Carborundum (silicon carbide). Freely solidifying copper slag can be used to make abrasives for polishing on steel, brass, Al & Zn/Al alloys satisfactory results were obtained. For example, Arizona manufactures a loose grain abrasive from air cooled slag with <0.1% free silica, so it is environmentally safe.

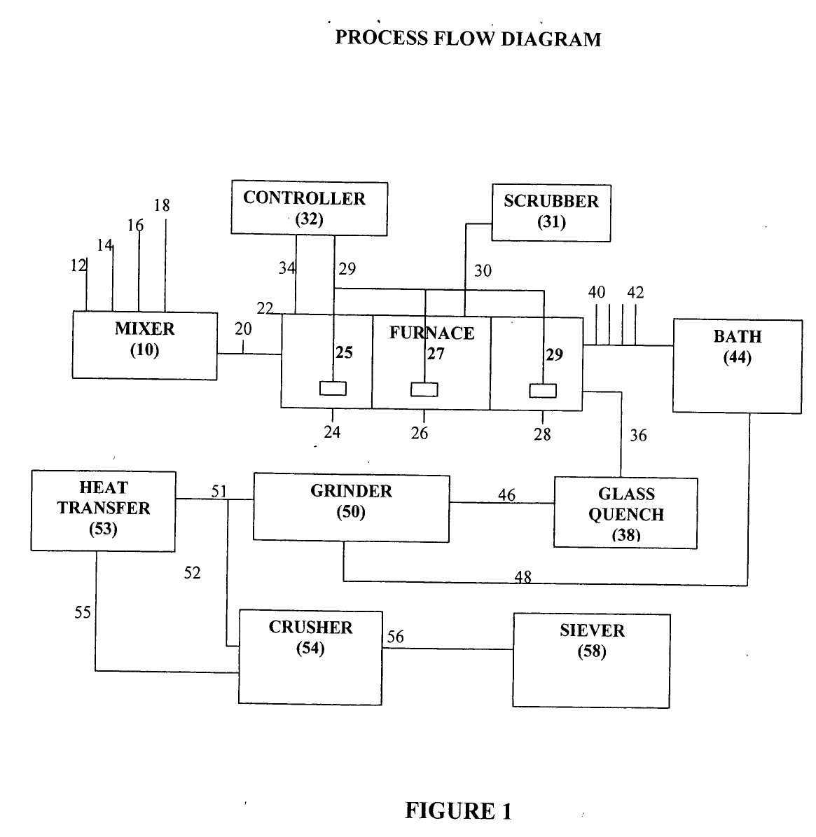

Referring to FIG. 1, a glass batch is produced by charging various reagents to mixer 10. Copper slag is charged to the mixer 10 via line 12. It is preferred that the copper slag used in the process have a particle size distribution of about 20 microns. Mesh sizes are about 8/20 mesh. The copper slag used in the process contains iron oxide.

Various physical and mechanical properties of copper slag listed below are very important for the technical chemist looking to manufacture value added products which many times is as important as the copper itself. Typical physical and mechanical properties of copper slag below will come into play many times over.

TABLE 1
TYPICAL PHYSICAL & MECHANICAL PROPERTIES
OF COPPER SLAG

| Appearance | Black, glassy, more vesicular |
|---|---|
| | when granulated |
| Unit weight | 2800-3800 (kg/m³) |
| Absorption, % | 0.13 |
| Bulk density | 144-162 lbs per cubic feet |
| Conductivity | 2.8-3.8 |
| Sp. gravity | 6-7 Moh |
| Moisture | <50% |
| Water soluble chloride | <50 ppm |
| Abrasion loss, % | 24.1 |
| Sodium sulphate soundness loss, % | 0.90 |
| Angle of internal fraction | 40-53 |

TABLE 2
TYPICAL COMPOSITION OF COPPER SLAG

| Element & | | |
|---|---|---|
| Compounds | Typical Concentration | Specific Concentration |
| Silicon Dioxide | 40% | 34.5% |
| Iron | 35 | 35.5 |
| Calcium Oxide | 5 | 3.6 |
| Zinc | 1.0 | 3.6 |
| Copper | 0.5 | 0.69 |
| Lead | 0.5 | 0.40 |
| Arsenic | 0.3 | 0.037 |
| Antimony | 0.3 | 0.03 |
| Nickel | 0.01 | |

Referring again to FIG. 1, glass is charged via line 14 to mixer 10. It is preferred that the glass so charged is crushed with a particle size distribution such that at least about 70 percent of its particles have a maximum dimension smaller than about 8.0 centimeters. It is even more preferred that glass used be glass cullet. One suitable glass cullet is soda lime glass cullet of mixed chops from residential glass recycling plants; it contains silica, sodium oxide, and calcium oxide. Instead of using soda lime glass and/or soda lime glass cullet, one may additionally and/or alternately use other glass compositions such as, for example, borosilicate glass, aluminosilicate glass, vicor glass, fused silica glass, borax glass, transparent mirror glass, and other glasses of suitable content. In embodiments, the glass charged via line 14 contains from at least about 20 percent of silicon dioxide in the glass. The copper slag and the glass are charged so that their weight/weight ratio is from about 2.0/1 to about 4.5/1.

Referring again to FIG. 1, from about 0 to about 20 weight silica sand can charge to mixer 10 via line 16. This silica sand preferably has a particle size distribution such that at least about 70 percent of its particles range in size from about 0.05 to about 2.0 millimeters. From about 15 to about 25 weight percent of glass flux material may be charged to mixer 10 via line 18. Other reagents also may be added to the glass batch in mixer 10. The glass batch from mixer 10 is conveyed via line 20 to furnace 22.

It is preferred, within furnace 22, to maintain the melt at a substantially constant shallow depth of from about 6 to about 12 inches. Maintaining such depth insures substantially that the same temperature will be found throughout the depth of the melt. In the embodiment illustrated in FIG. 1, furnace 22 is equipped with at least three heating zones, via heating zones 24, 26, and 28. Preferably, heating zone 24 is a preheating zone in which the furnace temperature is maintained at from about 1,200 to about 2,600 degrees Fahrenheit. A sensor, such as sensor 25, can monitor the temperature within the glass batch. The mix is maintained in this zone 24 until substantially all of it is melted.

The preheated mix is then subjected to a temperature of from about 2,300 to about 2,800 degrees Fahrenheit in a melting zone 26. Melt zone sensor 27 monitors the temperature of the melt and determines when, in fact, it has been completely melted. In embodiments, the “soak time” during which the preheated mix is in the melting zone generally is from about 3 to about 5 hours.

During the melting process in zone 26, gases are produced that may include hazardous substances in liquid, vapor, or particulate form. Thus, gasses such as chlorine, fluorine, sulfur dioxide, mercury, chromium, and the like may be evolved. The off-gasses produced during the melting process are preferably passed via line 30 to scrubber 31.

Referring again to FIG. 1, after the melt (copper slag, glass and other constituents) has been maintained in the melting zone 26 for the desired soak time, it is then passed to crystallization zone 28. In this crystallization zone 28, the melt is maintained in a substantially motionless state at a flow rate of less than about one inch per minute while being subjected to a temperature of from about 2,400 to about 2,900 degrees Fahrenheit. A crystallization sensor 29 is maintained in the melt to monitor the temperature within the melt. The crystallization sensor 29 is operatively connected to acontroller which, via feedback line 34, is adapted to maintain the desired temperatures in zones 24, 26, and 28.

The partially crystallized melt from crystallization zone 28 is passed via line 36 to a glass quench 38. In embodiments, when quenching the glass/ceramic melt from furnace segment 28, the temperature of the melt can be reduced from its initial temperature (of from about 2300 to about 3000 degrees Fahrenheit) to a temperature of less than 500 degrees Fahrenheit in less than about 10 seconds. Thus, one may withdraw molten glass/ceramic material from furnace segment 28 into a molten glass stream 40 and blast one or more streams 42 of water against the molten flow 40 at a high pressure of from about 40 to about 60 pounds per square inch. In the process, following such high pressure quenching, the quenched material drops into a quenching bath of hot or boiling water 44.

The quenched glass/ceramic mix from either quench 38 and/or bath 44 is/are passed via lines 46 to grinder 50, in which the size of the quenched material is reduced so that substantially all of the particles have a predetermeined largest dimension, such as less than about 5 millimeters. After glass/ceramic mix has been ground in grinder 50, the ground material may then be passed via line 52 to crusher 54 in which the glass/ceramic material is crushed to desired sieve ranges. In embodiments, the glass/ceramic composition is crushed so that the particles pass through a 20 mesh sieve (841 microns) but are retained on a 40 mesh sieve (420 microns); this is referred to as a 20/40 compact. Alternatively, embodiments can provide that, prior to being fed to the crusher 54 and grinder 50, the material first passes via line 51 to a heat treatment furnace 53.

In the heat treater 53, embodiments subject the ground glass/ceramic material to a temperature of from about 740 to about 760 degrees Centigrade for about 2.5 to about 3.5 hours. The material is first raised from ambient to the soak temperature for from about 2.5 to about 3.5 hours, and then cooled over a period of at least 8 hours.

The heat treated material from heat treater 53 can then be passed via line 55 to crusher 54. The crushed material from crusher 54, is passed via line 56 to sieve 58, wherein the crushed particles have been separated into various sieve sizes and/or compacts.

It will be appreciated that various of the above-disclosed and other features and functions, or alternatives thereof, may be desirably combined into many other different systems or applications. Also that various presently unforeseen or unanticipated alternatives, modifications, variations or improvements therein may be subsequently made by those skilled in the art which are also intended to be encompassed by the following claims.

What is claimed is:

1. A method of producing a glass-ceramic composition comprising providing copper slag, providing at least one glass material, providing at least one ceramic material, and mixing the copper slag, the at least one glass material, and the at least one ceramic material.

2. The method of claim 1 in which providing the at least one glass material comprises providing glass cutlet and providing the at least one ceramic material comprises providing silica sand.

3. The method of claim 1 wherein mixing copper slag with glass cutlet and silica sand comprises providing 60 wt %±10 wt % copper slag, providing 20 wt %±5 wt % glass cullet, and providing 20 wt %±7 wt % silica sand.

4. The method of claim 1 further comprises preheating the copper slag.

5. The method of claim 5 wherein preheating the copper slag comprises heating the slag to between 1200° F. and 2600° F.

6. The method of claim 1 further comprising melting mixed copper slag, at least one glass material, and at least one ceramic material between 2300° F. and 2800° F., quenching at 500° F. to solidify and crystallize the mixture, and grinding the solidified quenched mixture to produce the glass-ceramic composition.

7. The method of claim 1 wherein providing at least one glass material comprises providing soda lime glass and providing alumina, and providing at least one ceramic material comprises providing silica sand.

8. The method of claim 7 wherein mixing copper slag with soda lime glass, alumina, and silica sand comprises providing 60 wt %±10 wt % copper slag, providing 10 wt %±2% soda lime glass, providing 10% wt of ±2% alumina, and providing 20 wt %±7 wt % silica sand.

9. The method of claim 1 wherein providing copper slag includes providing copper slag with particulates comprise 30 to 50 wt % of at least one iron oxide and 1.0 to 4.5 wt % zinc oxide.

10. The method of claim 1 wherein providing the at least one glass material comprises providing at least one glass material with at least 70% particles having a maximum dimension smaller than 8.0 centimeters.

11. The method of claim 10 in which providing the at least one glass material further comprises providing at least one glass material contains 20% of silicon dioxide.

12. The method of claim 1 in which providing silica sand comprises providing silica sand with a particle size distribution such that at least 70 wt % of its particle range in size from 0.05 mm to 2.0 mm.

13. The method of claim 5 in which heating copper slag to between 1200° F. and 2600° F. comprises providing a preheat zone, providing a melting zone, and providing a crystallization zone, bringing the slag up to a temperature between 1200 and 2600° F. in the preheat zone, heating the copper slag to between 2300 and 2800° F. in the melting zone for three to five hours, and heating the copper slag to 500° F. in the crystalline zone.

14. The method of claim 13 wherein the copper slag melt is maintained in the crystallization zone at a flow rate of less then one inch per minute.

15. The method of claim 6 in which the quenching the mixture comprises quenching the copper slag from a temperature between 2300 and 3000° F. down to less then 5000° F. in less then 10 seconds.

16. The method of claim 6 wherein heat treating the quenched mixture comprises heat treating at a temperature between 1350 and 1400° F. down to less then 500° F. in less then 10 seconds.

17. The method of claim 6 wherien grinding the quenched mixture comprises grinding the quenched mixture to a particle size of less then 5 mm and then grinding down further to a selective size less than 1 mm.

18. The method of claim 17 wherein grinding down further comprises grinding down to a particle size between 8-320 U.S. Mesh sizes.

19. The method of claim 1 further comprising ensuring the glass-ceramic composition contains sufficient ferrite that the glass-ceramic composition can be separated from other materials by magnetic attraction.

20. The method of claim 1 further comprising making the glass-ceramic into a fine abrasive.

21. The method of claim 1 further comprising making the glass-ceramic into beads with a hole extending half-way through the diameter for oil fracs.

22. The method of claim 1 further comprising forming the glass-ceramic into insulation fibers.

23. The method of claim 1 further comprising forming the glass-ceramic material into a proponent, suspending the proponent in drilling fluid during a portion of a drilling operation to keep a fracture open when fluid is withdrawn.
